(19) United States
(12) Patent Application Publication
(10) Pub. No.: US 2026/0155669 A1
(43) Pub. Date: Jun. 4, 2026

(54) CHARGER AND CONTROL METHOD THEREFOR

(71) Applicant: Nanjing Chervon Industry Co., Ltd., Nanjing (CN)

(72) Inventors: Rong Fan, Nanjing (CN); Tianxiang Wang, Nanjing (CN)

(21) Appl. No.: 19/336,759

(22) Filed: Sep. 23, 2025

(30) Foreign Application Priority Data
Nov. 29, 2024 (CN) 202411746145.6

(51) Int. Cl. H02J 7/00

(52) U.S. Cl. CPC H02J 7/94; H02J 7/44; H02J 7/80

(57) ABSTRACT

A charger includes a battery pack interface for connecting a battery pack to enable the charger to charge the battery pack; a communication module configured to communicate with the battery pack; a detection module configured to detect an actual current output by the charger; and a control module electrically connected to the communication module and the detection module. The control module is configured to acquire a current demand instruction from the battery pack through the communication module; acquire the actual current through the detection module; and adjust a control parameter according to the current demand instruction and the actual current, where the control parameter is used for controlling the actual current output by the charger. The technical solutions can reduce an operational amplifier and peripheral devices of the charger and ensure that the output current of the charger is stable and controllable, facilitating cost reduction.

### RELATED APPLICATION INFORMATION

This application claims the benefit under 35 U.S.C. § 119(a) of Chinese Patent Application No. CN 202411746145.6, filed on Nov. 29, 2024, which is incorporated by reference in their entirety herein.

### TECHNICAL FIELD

The present application relates to the technical field of tools and devices and, in particular, to a charger and a control method therefor.

### BACKGROUND

A charger in the related art implements its constant voltage/constant current control through hardware control. The hardware control specifically adopts voltage and current loops built with an operational amplifier. However, the operational amplifier along with peripheral devices has a relatively high cost. Moreover, the charger adopts a single-layer board, and an increase in the number of devices affects a wiring layout and easily causes errors.

Another charger in the existing art implements a simple layout on a single-layer board by packaging an operational amplifier with a microcontroller unit, facilitating an improvement in production efficiency. However, such a solution is excessively high in cost and is not conducive to cost reduction.

Another charger in the existing art adopts a control solution of voltage and current loops without an operational amplifier and implements its constant voltage/constant current control through software control. However, such a solution requires a constant voltage loop to enable the operation of a constant current loop. Meanwhile, due to the lack of the operational amplifier, the detected current cannot be amplified, and stable current control cannot be achieved.

This part provides background information related to the present application, and the background information is not necessarily the existing art.

### SUMMARY

An object of the present application is to solve or at least alleviate part or all of the preceding problems. Therefore, an object of the present application is to provide a charger and a control method therefor.

To achieve the preceding object, the present application adopts the technical solutions below.

In a first aspect, the present application provides a charger. The charger includes a battery pack interface, a communication module, a detection module, and a control module.

The battery pack interface is used for connecting a battery pack to enable the charger to charge the battery pack.

The communication module is configured to communicate with the battery pack.

The detection module is configured to detect an actual current output by the charger.

The control module is electrically connected to the communication module and the detection module.

The control module is configured to acquire a current demand instruction from the battery pack through the communication module; acquire the actual current through the detection module; and adjust a control parameter according to the current demand instruction and the actual current, where the control parameter is used for controlling the actual current output by the charger.

In a second aspect, the present application provides a control method for a charger. The control method for a charger includes the steps below.

A current demand instruction of a battery pack is acquired, where the current demand instruction includes a current increase instruction, a current decrease instruction, or a present current holding instruction.

An actual current output by the charger is acquired.

A control parameter is adjusted according to the current demand instruction and the actual current, where the control parameter is used for controlling an output current of the charger.

When the current demand instruction is the current increase instruction, it is determined whether a predicted output current of the charger is less than or equal to a preset current upper limit under the control of a first adjusted control parameter.

If so, the output current of the charger is controlled with the first adjusted control parameter.

In a third aspect, the present application provides a charger. The charger includes a battery pack interface, a communication module, a detection module, and a control module.

The battery pack interface is used for connecting a battery pack to enable the charger to charge the battery pack.

The communication module is configured to communicate with the battery pack.

The detection module is configured to detect an operating parameter of the battery pack or the charger.

The control module is electrically connected to the communication module and the detection module, and the control module is configured to acquire a voltage of the battery pack; and set a target output voltage of the charger according to the voltage of the battery pack and a detection error range of the detection module.

The present application has the following benefits: the charger includes the battery pack interface, the communication module, the detection module, and the control module. The battery pack interface is used for connecting the battery pack to enable the charger to charge the battery pack. The communication module is configured to communicate with the battery pack to acquire the current demand instruction from the battery pack. The detection module is configured to detect the actual current output by the charger. The control module is electrically connected to the communication module and the detection module, and the control module is configured to acquire the current demand instruction from the battery pack through the communication module, acquire the actual current through the detection module, and adjust the control parameter according to the current demand instruction and the actual current to control the output current of the charger, so that the output current of the charger is stabilized. Thus, with an operational amplifier and peripheral devices of the charger reduced, it can be ensured that the output current of the charger is stable and controllable, facilitating cost reduction.

### BRIEF DESCRIPTION OF THE DRAWINGS

FIG. 1 is a circuit block diagram of a charger according to an example of the present application.

FIG. 2 is a graph showing a comparison between a curve of a charge current of a charger according to an example of the present application and a curve of a charge current of a charger in the existing art.

FIG. 3 is a flowchart of a control method for a charger according to an example of the present application.

FIG. 4 is a flowchart of another control method for a charger according to an example of the present invention.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

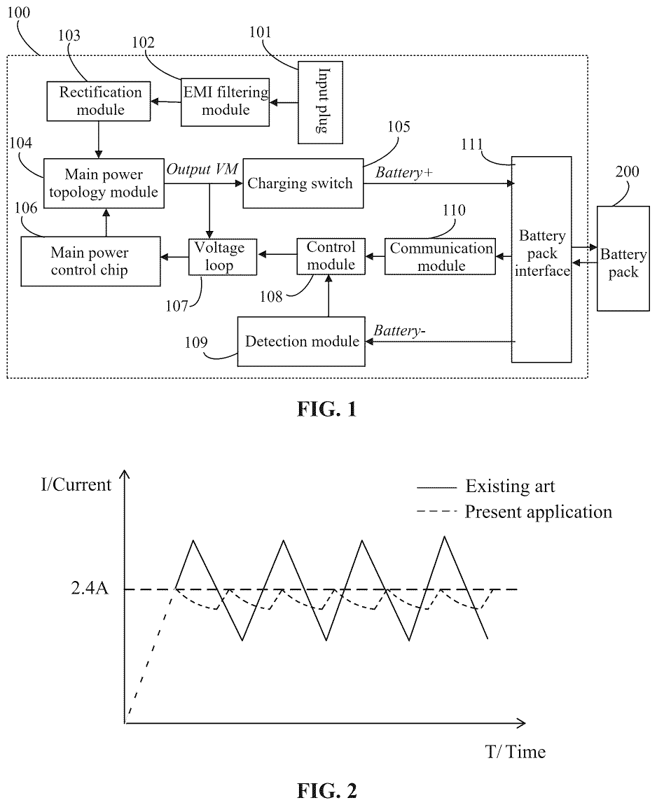

FIG. 1 is a circuit block diagram of a charger according to an example of the present application. Referring to FIG. 1, a charger 100 includes an input plug 101, an electromagnetic interference (EMI) filtering module 102, a rectification module 103, a main power topology module 104, a charging switch 105, a main power control chip 106, a voltage loop 107, a control module 108, a detection module 109, a communication module 110, and a battery pack interface 111. The input plug 101 is used for connecting a power supply to enable the power supply to provide electrical energy for a battery pack 200 through the charger 100. The other end of the input plug 101, the EMI filtering module 102, the rectification module 103, the main power topology module 104, the charging switch 105, and a positive terminal Battery+of the battery pack interface 111 are electrically connected in sequence. A negative terminal Battery-of the battery pack interface 111, the detection module 109, the control module 108, the voltage loop 107, the main power control chip 106, and the main power topology module 104 are electrically connected in sequence. The voltage loop 107 is also electrically connected to an output terminal of the main power topology module 104 and configured to collect an output voltage of the main power topology module 104. The battery pack interface 111 is used for connecting the battery pack 200 to enable the charger 100 to charge the battery pack 200. The communication module 110 is configured to communicate with the battery pack 200. The detection module 109 is configured to detect an actual current output by the charger 100. The control module 108 is electrically connected to the communication module 110 and the detection module 109. In some examples, the detection module 109 includes a current detection circuit. In some examples, the main power topology module 104 includes a flyback topology circuit or an LLC topology circuit.

It is to be noted that the charger 100 according to the example of the present application is a low-power charger. In some examples, output power of the charger 100 is less than or equal to 150 W. In some examples, the output power of the charger 100 is less than or equal to 120 W. In some examples, the output power of the charger 100 is less than or equal to 60 W.

The control module 108 is configured to acquire a current demand instruction from the battery pack 200 through the communication module 110; acquire the actual current through the detection module 109; and adjust a control parameter according to the current demand instruction and the actual current.

The control parameter is used for controlling the actual current output by the charger 100.

The current demand instruction may be understood as an instruction of the battery pack 200 to demand a charge current when the battery pack 200 is charged. In some examples, the current demand instruction includes a current increase instruction, a current decrease instruction, or a present current holding instruction. The current increase instruction may be understood as an instruction to increase the charge current. The current decrease instruction may be understood as an instruction to decrease the charge current. The present current holding instruction may be understood as an instruction to hold the charge current at a present current.

In some examples, the current demand instruction is represented by a pulse-width modulated signal. Specifically, the main power topology module 104 includes multiple metal- oxide-semiconductor (MOS) transistor switches, and a switching frequency of each MOS transistor switch is controlled to implement a magnitude of the actual current output by the charger 100. When the battery pack 200 requires an increase in the charge current, the battery pack 200 may send an instruction to increase the conduction ratio of corresponding MOS transistor switches, that is, an instruction to increase a duty cycle of the pulse-width modulated signal. When the battery pack 200 requires a decrease in the charge current, the battery pack 200 may send an instruction to decrease the conduction ratio of the corresponding MOS transistor switches, that is, an instruction to decrease the duty cycle of the pulse-width modulated signal.

In some examples, the battery pack 200 directly sends the current demand instruction. In some examples, the communication module 110 acquires an operating parameter of the battery pack 200 and determines the current demand instruction according to the operating parameter of the battery pack 200.

The detection module 109 is configured to detect the actual current output by the charger 100. The actual current output by the charger 100 is the charge current of the battery pack 200. In some examples, the detection module 109 includes the current detection circuit configured to acquire the actual current output by the charger 100.

In an optional example, the control parameter is an output voltage of the charger 100. The output voltage of the charger 100 is adjusted according to the current demand instruction and the actual current so that the actual current output by the charger 100 is stabilized around a target output current.

In this example, the charger includes the battery pack interface, the communication module, the detection module, and the control module. The battery pack interface is used for connecting the battery pack to enable the charger to charge the battery pack. The communication module is configured to communicate with the battery pack to acquire the current demand instruction from the battery pack. The detection module is configured to detect the actual current output by the charger. The control module is electrically connected to the communication module and the detection module, and the control module is configured to acquire the current demand instruction from the battery pack through the communication module, acquire the actual current through the detection module, and adjust the control parameter according to the current demand instruction and the actual current to control an output current of the charger, so that the output current of the charger is stabilized. Thus, with an operational amplifier and peripheral devices of the charger reduced, it can be ensured that the output current of the charger is stable and controllable, facilitating cost reduction.

It is to be noted that the charger 100 of the present application excludes a current operational amplifier, thereby avoiding a need to provide the charger 100 with peripheral devices of the current operational amplifier and facilitating reduction in the volume and manufacturing cost of the charger 100.

FIG. 2 is a graph showing a comparison between a curve of a charge current of a charger according to an example of the present application and a curve of a charge current of a charger in the existing art. Referring to FIG. 2, the output current of the charger 100 according to the example of the present application is stably maintained around a target current of 2.4 A with relatively small fluctuations. However, an actual current output by the charger in the existing art has relatively large fluctuations.

In some examples, when the current demand instruction is the current increase instruction, the control module 108 is configured to determine whether a predicted output current of the charger 100 is less than or equal to a preset current upper limit under the control of a first adjusted control parameter; and if so, control, with the first adjusted control parameter, the actual current output by the charger 100.

The first adjusted control parameter may be understood as a control parameter adjusted according to the current demand instruction and the actual current when the current demand instruction is the current increase instruction.

In some examples, the first adjusted control parameter is a present control parameter minus a preset current increase parameter. The preset current increase parameter may be determined according to a stability requirement on the actual current output by the charger 100. In some examples, the preset current increase parameter is 1. Each adjustment is performed by a fixed adjustment amount so that the whole adjustment process can be stable and smooth.

The predicted output current of the charger 100 may be understood as a theoretical output current of the charger 100 under the control of the first adjusted control parameter.

The preset current upper limit may be determined according to characteristics of the battery pack 200. In some examples, the preset current upper limit is less than or equal to a maximum charge current allowed by the battery pack 200.

In some examples, when the current demand instruction is the current increase instruction, the control module 108 is configured to, if the predicted output current of the charger 100 is greater than the preset current upper limit under the control of the first adjusted control parameter, control, with the present control parameter, the actual current output by the charger 100.

Specifically, when the current demand instruction is the current increase instruction, a current increase parameter is equal to the preset current increase parameter, and the first adjusted control parameter is equal to the present control parameter minus the preset current increase parameter. Then, it is determined whether the predicted output current of the charger 100 is less than or equal to the preset current upper limit under the control of the first adjusted control parameter. If the predicted output current of the charger 100 is less than or equal to the preset current upper limit, it indicates that the output current of the charger 100 does not exceed the preset current upper limit under the control of the first adjusted control parameter, so that the actual current output by the charger 100 can be controlled with the first adjusted control parameter to satisfy the current demand instruction of the battery pack 200. Conversely, if the predicted output current of the charger 100 is greater than the preset current upper limit, it indicates that the output current of the charger 100 exceeds the preset current upper limit under the control of the first adjusted control parameter, so that the present control parameter is maintained to control the actual current of the charger 100, so as to prevent the battery pack 200 from being damaged.

In some examples, when the current demand instruction is the current decrease instruction, the control module 108 is configured to determine whether an actual current of the charger 100 is greater than a preset current lower limit; and if so, control, with a second adjusted control parameter, the actual current output by the charger 100.

In some examples, when the current demand instruction is the current decrease instruction, the control module 108 is configured to, if the actual current of the charger 100 is less than or equal to the preset current lower limit, control, with the present control parameter, the output current of the charger 100.

The second adjusted control parameter may be understood as a control parameter adjusted according to the current demand instruction and the actual current when the current demand instruction is the current decrease instruction.

In some examples, the second adjusted control parameter is the present control parameter plus a preset current decrease parameter. The preset current decrease parameter may be determined according to the stability requirement on the actual current output by the charger 100. In some examples, the preset current decrease parameter is 1. Each adjustment is performed by a fixed adjustment amount so that the whole adjustment process can be stable and smooth.

The preset current lower limit may be determined according to the characteristics of the battery pack 200. In some examples, the preset current lower limit is less than or equal to a minimum charge current allowed by the battery pack 200, thereby preventing the actual current output by the charger 100 from being reduced to a current value as a minimum resolution of the charger 100.

Specifically, when the current demand instruction is the current decrease instruction, it is determined whether the actual current of the charger 100 is greater than or equal to the preset current lower limit. If the actual current of the charger 100 is greater than the preset current lower limit, the actual current output by the charger 100 is controlled with the second adjusted control parameter to satisfy the current demand instruction of the battery pack 200. Conversely, if the actual current of the charger 100 is less than or equal to the preset current lower limit, the actual current output by the charger 100 is controlled with the present control parameter, so as to prevent the actual current output by the charger 100 from being lower than the current value as the minimum resolution of the charger 100.

In some examples, when the current demand instruction is the current decrease instruction, the control module 108 is configured to determine whether the predicted output current of the charger 100 is greater than or equal to the preset current lower limit under the control of the second adjusted control parameter; and if so, control, with the second adjusted control parameter, the actual current output by the charger 100.

In some examples, when the current demand instruction is the current decrease instruction, the control module 108 is further configured to, if the predicted output current of the charger 100 is less than the preset current lower limit under the control of the second adjusted control parameter, control, with the present control parameter, the output current of the charger 100.

Specifically, when the current demand instruction is the current decrease instruction, a current decrease parameter is equal to the preset current decrease parameter, and the second adjusted control parameter is equal to the present control parameter plus the preset current decrease parameter. Then, it is determined whether the predicted output current of the charger 100 is greater than or equal to the preset current lower limit under the control of the second adjusted control parameter. If the predicted output current of the charger 100 is greater than or equal to the preset current lower limit, it indicates that the output current of the charger 100 is not lower than the preset current lower limit under the control of the second adjusted control parameter, so that the actual current output by the charger 100 can be controlled with the second adjusted control parameter to satisfy the current demand instruction of the battery pack 200. Conversely, if the predicted output current of the charger 100 is less than the preset current lower limit, it indicates that the output current of the charger 100 is lower than the preset current lower limit under the control of the second adjusted control parameter, so that the present control parameter is maintained to control the actual current of the charger 100, so as to prevent the actual current output by the charger 100 from being lower than the current value as the minimum resolution of the charger 100.

In some examples, when the current demand instruction is the present current holding instruction, it indicates that the actual current output by the charger 100 at a present instant can satisfy the demand of the battery pack 200 for the charge current, and the control module 108 is configured to maintain the present control parameter so that the actual current output by the charger 100 is stabilized at the target output current.

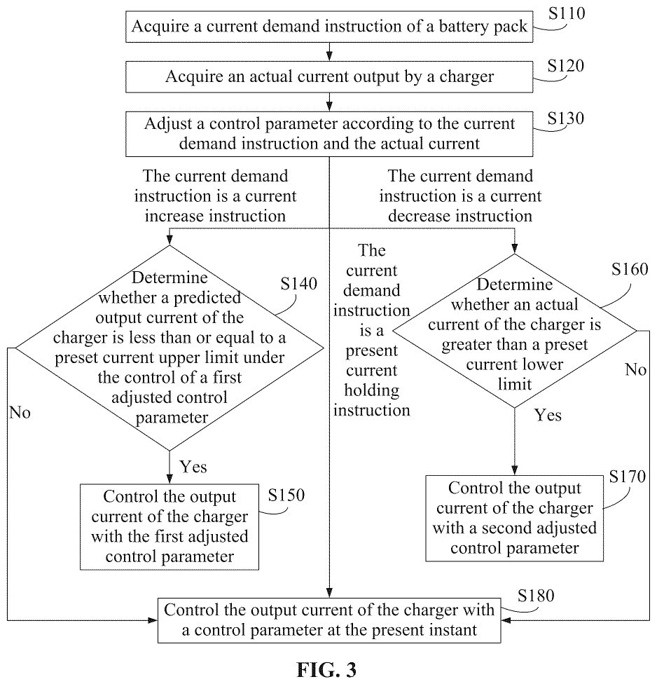

Based on the same concept, an example of the present application further provides a control method for a charger. FIG. 3 is a flowchart of a control method for a charger according to an example of the present application. Referring to FIG. 3, the control method for the charger 100 of the present application includes the steps below.

In S110, a current demand instruction of a battery pack is acquired.

The current demand instruction includes a current increase instruction, a current decrease instruction, or a present current holding instruction. In some examples, the current demand instruction is represented by a pulse-width modulated signal.

In some examples, acquiring the current demand instruction includes acquiring an operating parameter of the battery pack 200, and determining the current demand instruction according to the operating parameter of the battery pack 200. The operating parameter of the battery pack 200 may include, but is not limited to, a voltage, a current, and/or a temperature of the battery pack 200.

In some examples, acquiring the current demand instruction includes acquiring the current demand instruction from the battery pack 200 through a communication module 110 of the charger 100.

In S120, an actual current output by the charger is acquired.

The charger 100 excludes a current operational amplifier. In some examples, the actual current output by the charger 100 is acquired through a detection module 109 of the charger 100.

It is to be noted that the charger 100 according to an example of the present application is a low-power charger. In some examples, output power of the charger 100 is less than or equal to 150 W. In some examples, the output power of the charger 100 is less than or equal to 120 W. In some examples, the output power of the charger 100 is less than or equal to 60 W.

In S130, a control parameter is adjusted according to the current demand instruction and the actual current.

The control parameter is used for controlling an output current of the charger.

Optionally, the control parameter is an output voltage.

In S140, when the current demand instruction is the current increase instruction, it is determined whether a predicted output current of the charger is less than or equal to a preset current upper limit under the control of a first adjusted control parameter. If so, S150 is performed. If not, S180 is performed.

In an optional example, the first adjusted control parameter is a present control parameter minus a preset current increase parameter. In some examples, the preset current increase parameter is 1.

In S150, the output current of the charger is controlled with the first adjusted control parameter.

In S160, when the current demand instruction is the current decrease instruction, it is determined whether an actual current of the charger is greater than a preset current lower limit. If so, S170 is performed. If not, S180 is performed.

A second adjusted control parameter is the present control parameter plus a preset current decrease parameter. In some examples, the preset current decrease parameter is 1.

In S170, the output current of the charger is controlled with the second adjusted control parameter.

In S180, the output current of the charger is controlled with a control parameter at a present instant.

In an optional example, when the current demand instruction is the present current holding instruction, the output current of the charger 100 is also controlled with the control parameter at the present instant.

In this example, the control parameter is adjusted according to the current demand instruction and the actual current. When the current demand instruction is the current increase instruction, if the predicted output current of the charger is less than or equal to the preset current upper limit under the control of the first adjusted control parameter, the output current of the charger is controlled with the first adjusted control parameter. When the current demand instruction is the current decrease instruction, if the predicted output current of the charger is greater than or equal to the preset current lower limit under the control of the second adjusted control parameter, the output current of the charger is controlled with the second adjusted control parameter. When the current demand instruction is the present current holding instruction, the output current of the charger is controlled with the control parameter at the present instant. Thus, with an operational amplifier and peripheral devices of the charger reduced, the actual current output by the charger can be maintained around a target output current, and the actual current fluctuates within a range less than or equal to a preset value, where the preset value is 10% of the target output current of the charger.

Based on the same concept, this example further provides a charger. With continued reference to FIG. 1, a charger 100 includes a battery pack interface 111, a communication module 110, a detection module 109, and a control module 108. The battery pack interface 111 is used for connecting a battery pack 200 to enable the charger 100 to charge the battery pack 200. The communication module 110 is configured to communicate with the battery pack 200. The detection module 109 is configured to detect an operating parameter of the battery pack 200 or the charger 100. In some examples, the operating parameter of the battery pack 200 may include, but is not limited to, a voltage of the battery pack 200. In some examples, the operating parameter of the charger 100 may include, but is not limited to, an actual current output by the charger 100.

It is to be noted that the charger 100 according to the example of the present application is a low-power charger. In some examples, output power of the charger 100 is less than or equal to 150 W. In some examples, the output power of the charger 100 is less than or equal to 120 W. In some examples, the output power of the charger 100 is less than or equal to 60 W.

The control module 108 is electrically connected to the communication module 110 and the detection module 109, and the control module 108 is configured to acquire the voltage of the battery pack 200 and set a target output voltage of the charger 100 according to the voltage of the battery pack 200 and a detection error range of the detection module 109.

The detection module 109 is configured to detect the operating parameter of the battery pack 200 or the charger 100, where multiple sampling devices are inevitably disposed, and each sampling device has an accuracy range. An accuracy error caused by the sampling devices may be understood as the detection error range of the detection module 109. In some examples, the detection error range is 0.2 V.

The target output voltage of the charger 100 may be understood as a predicted output voltage of the charger 100, and the charger 100 operates for the purpose of outputting the target output voltage.

In some examples, the detection module 109 includes at least one sampling device including a sampling switch. The detection error range may include, but is not limited to, a voltage drop across the sampling switch and an accuracy of each sampling device.

In some examples, the detection error range is sent by the detection module 109 to the control module 108 and pre-stored in the control module 108.

It is to be understood that in a process of the charger 100 charging the battery pack 200, the detection module 109 needs to detect, in real time, the actual current output by the charger 100. Since the detection module 109 is connected in parallel to the battery pack interface 111, and the detection module 109 needs to be powered by the charger 100 during operation of the detection module 109, an output voltage of the charger 100 experiences a voltage drop in a branch of the detection module 109.

In some examples, the control module 108 is configured to set a sum of the voltage of the battery pack 200 and the detection error range as the target output voltage of the charger 100 so that an actual output voltage of the charger 100 further approximates the voltage of the battery pack 200, and the actual output voltage of the charger 100 achieves an accuracy level of +0.01.

In some examples, the charger 100 includes a charging switch. The control module 108 is configured to control the charging switch to be turned on after a delay of a preset time.

The charging switch is configured to control whether the charger 100 charges the battery pack 200. When the charging switch is turned on, the charger 100 charges the battery pack 200. Conversely, when the charging switch is turned off, the charger 100 cannot charge the battery pack 200.

In some examples, the charging switch is a signal switch. Compared with a high-current switch, the signal switch has a significantly reduced cost. However, the signal switch cannot withstand a large surge current due to a voltage difference. The control method for the charger 100 according to this example enables the actual current output by the charger 100 to be stabilized around a target output current, and the actual current fluctuates within a range less than or equal to 10% of the target output current so that the charger 100 according to this example can use the signal switch as the charging switch, further reducing the cost of the charger 100.

The preset time may be set according to characteristics of the charger 100. It is to be understood that the charger 100 includes a hardware portion and a software portion, and the hardware portion and the software portion each require a certain time to respond to the control module 108 of the charger 100. After the hardware portion and the software portion of the charger 100 make full responses, the charger 100 can output a stable current to charge the battery pack 200.

In some examples, the preset time is greater than or equal to a sum of a software response time and a hardware response time of the charger 100. After both the software portion and the hardware portion of the charger 100 make full responses, the charging switch is turned on so that the charger 100 charges the battery pack 200, facilitating an improvement in the stability of the actual current output by the charger 100. In some examples, the preset time is 800 ms.

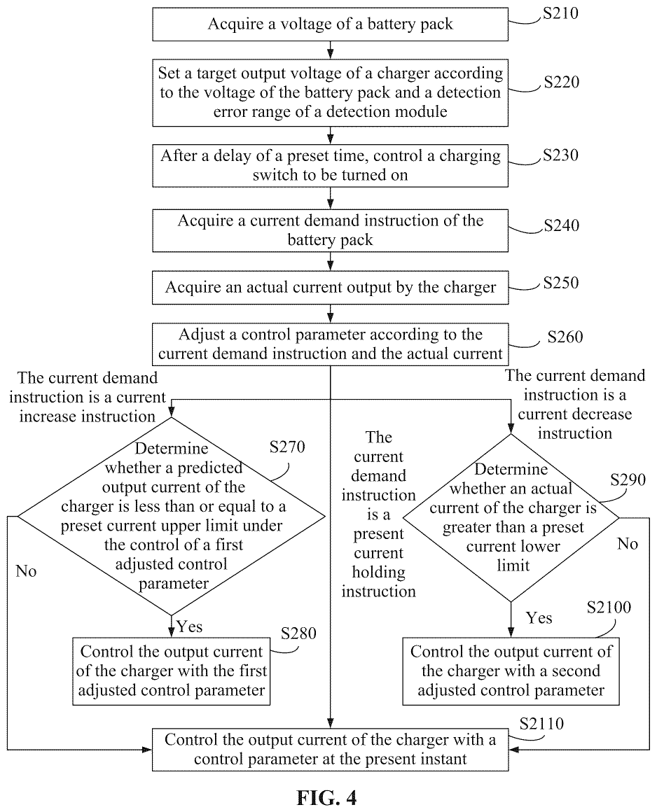

Based on the same concept, this example further provides another control method for a charger 100, which is used for controlling the preceding charger 100 to charge a battery pack 200. FIG. 4 is a flowchart of another control method for a charger according to an example of the present invention. Referring to FIG. 4, the control method for a charger includes the steps below.

In S210, a voltage of the battery pack is acquired.

In S220, a target output voltage of the charger is set according to the voltage of the battery pack and a detection error range of a detection module.

In S230, after a delay of a preset time, a charging switch is controlled to be turned on.

In S240, a current demand instruction of the battery pack is acquired.

The current demand instruction includes a current increase instruction, a current decrease instruction, or a present current holding instruction. In some examples, the current demand instruction is represented by a pulse-width modulated signal.

In S250, an actual current output by the charger is acquired.

The charger 100 excludes a current operational amplifier.

In S260, a control parameter is adjusted according to the current demand instruction and the actual current.

In S270, when the current demand instruction is the current increase instruction, it is determined whether a predicted output current of the charger is less than or equal to a preset current upper limit under the control of a first adjusted control parameter. If so, S280 is performed. If not, S2110 is performed.

In an optional example, the first adjusted control parameter is a present control parameter minus a preset current increase parameter. In some examples, the preset current increase parameter is 1.

In S280, the output current of the charger is controlled with the first adjusted control parameter.

In S290, when the current demand instruction is the current decrease instruction, it is determined whether an actual current of the charger is greater than a preset current lower limit. If so, S2100 is performed. If not, S2110 is performed.

A second adjusted control parameter is the present control parameter plus a preset current decrease parameter. In some examples, the preset current decrease parameter is 1.

In S2100, the output current of the charger is controlled with the second adjusted control parameter.

In S2110, the output current of the charger is controlled with a control parameter at a present instant.

In an optional example, when the current demand instruction is the present current holding instruction, the output current of the charger 100 is controlled with the control parameter at the present instant.

The control method for a charger according to this example can control the charger according to any example of the present invention to charge the battery pack and thus has the beneficial effects of the charger according to any example of the present invention. For similarities, reference is made to the preceding description, and the details are not repeated here.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A charger, comprising:
a battery pack interface that connects to a battery pack to enable the charger to charge the battery pack;
a communication module that communicates with the battery pack;
a detection module that detects an actual current output by the charger; and
a control module, electrically connected to the communication module and the detection module, that acquires a current demand instruction from the battery pack through the communication module; acquires the actual current through the detection module; and adjusts a control parameter used for controlling the actual current output by the charger according to the current demand instruction and the actual current.

2. The charger of claim 1, wherein the current demand instruction comprises a current increase instruction, a current decrease instruction, or a present current holding instruction.

3. The charger of claim 2, wherein the current demand instruction is represented by a pulse-width modulated signal.

4. The charger of claim 2, wherein, when the current demand instruction is the current increase instruction, the control module controls, with a first adjusted control parameter, the actual current output by the charger when the control module determines that a predicted output current of the charger is less than or equal to a preset current upper limit under the control of the first adjusted control parameter and controls, with a present control parameter, the actual current output by the charger when the control module determines that the predicted output current of the charger is not less than or equal to the preset current upper limit under the control of the first adjusted control parameter.

5. The charger of claim 4, wherein the first adjusted control parameter is the present control parameter minus a preset current increase parameter.

6. The charger of claim 2, wherein, when the current demand instruction is the current decrease instruction, the control module controls, with a second adjusted control parameter, the actual current output by the charger when the control module determines that the actual current of the charger is greater than a preset current lower limit and controls, with a present control parameter, an output current of the charger when the control module determines that the actual current of the charger is greater than the preset current lower limit and controls.

7. The charger of claim 6, wherein the second adjusted control parameter is the present control parameter plus a preset current decrease parameter.

8. The charger of claim 2, wherein, when the current demand instruction is the present current holding instruction, the control module controls, with a present control parameter, an output current of the charger.

9. The charger of claim 1, wherein the control parameter is an output voltage.

10. The charger of claim 1, wherein the charger excludes a current operational amplifier.

11. The charger of claim 1, wherein output power of the charger is less than or equal to 150 W.

12. A control method for a charger, comprising:
acquiring a current demand instruction of a battery pack, wherein the current demand instruction comprises a current increase instruction, a current decrease instruction, or a present current holding instruction;
acquiring an actual current output by the charger;
adjusting a control parameter according to the current demand instruction and the actual current, wherein the control parameter is used for controlling an output current of the charger; and
when the current demand instruction is the current increase instruction, controlling, with a first adjusted control parameter, the output current of the charger when a predicted output current of the charger is less than or equal to a preset current upper limit under the control of the first adjusted control parameter and controlling, with a present control parameter, the output current of the charger when the control module determines that the predicted output current of the charger is not less than or equal to the preset current upper limit under the control of the first adjusted control parameter.

13. The control method for a charger of claim 12, wherein the control parameter is an output voltage, and the first adjusted control parameter is the present control parameter minus a preset current increase parameter.

14. The control method for a charger of claim 12, further comprising, when the current demand instruction is the current decrease instruction, controlling, with a second adjusted control parameter, the output current of the charger when an actual current of the charger is greater than a preset current lower limit and controlling, with the present control parameter, the output current of the charger when the actual current of the charger is not greater than the preset current lower limit, wherein the control parameter is an output voltage, and the second adjusted control parameter is the present control parameter plus a preset current decrease parameter.

15. The control method for a charger of claim 12, further comprising, when the current demand instruction is the present current holding instruction, controlling, with a control parameter at a present instant, the output current of the charger, wherein the control parameter is an output voltage.

16. The control method for a charger of claim 12, wherein the actual current output by the charger fluctuates within a range less than or equal to a preset value and the preset value is 10% of a target output current of the charger.

17. The control method for a charger of claim 12, wherein acquiring the current demand instruction comprises: acquiring an operating parameter of the battery pack; and determining the current demand instruction according to the operating parameter; or acquiring the current demand instruction from the battery pack through a communication module of the charger.

18. A charger, comprising:
a battery pack interface that connects to a battery pack to enable the charger to charge the battery pack;
a communication module that communicates with the battery pack;
a detection module that detects an operating parameter of the battery pack or the charger; and
a control module, electrically connected to the communication module and the detection module, that acquires a voltage of the battery pack and sets a target output voltage of the charger according to the voltage of the battery pack and a detection error range of the detection module.

19. The charger of claim 18, wherein the detection module comprises at least one sampling device comprising a sampling switch; and the detection error range comprises a voltage drop across the sampling switch and an accuracy of each of the at least one sampling device.

20. The charger of claim 18, wherein the control module sets a sum of the voltage of the battery pack and the detection error range as the target output voltage of the charger.
